(19) United States
(12) Patent Application Publication
(10) Pub. No.: US 2012/0329646 A1
(43) Pub. Date: Dec. 27, 2012

(54) THERMAL RECORDING MATERIAL AND METHOD FOR PRODUCING THE SAME

(75) Inventor: Shinichiro Matsumoto, Tokyo (JP)

(73) Assignee: MITSUBISHI PAPER MILLS LIMITED, Chiyoda-ku, Tokyo (JP)

(21) Appl. No.: 13/520,809

(22) PCT Filed: Feb. 23, 2011
(86) PCT No.: PCT/JP2011/053930

§ 371 Date: Aug. 20, 2012

(30) Foreign Application Priority Data
Mar. 4, 2010 (JP) 2010-047273

(51) Int. Cl. B41M 5/28; B05D 3/02

(52) U.S. Cl. 503/200; 427/150

(57) ABSTRACT

Provided is a thermal recording material comprising a heat-sensitive recording layer for color formation by heat and a protective layer stacked in this order on a support, the protective layer at least containing an acetoacetyl-modified polyvinyl alcohol crosslinked by a glyoxylate and an epichlorohydrin resin.

### TECHNICAL FIELD

The present invention relates to a thermal recording material comprising a heat-sensitive recording layer for color formation by heat and a protective layer stacked in this order on a support. Specifically, the present invention relates to a thermal recording material that has an excellent anti-sticking property and a favorable offset printability, and a method for producing the same.

### BACKGROUND ART

Generally, a thermal recording material comprises, on a support, a heat-sensitive recording layer containing an electron-donating dye precursor, which is usually colorless or light-colored, and an electron-accepting compound as main components. By application of heat to such a thermal recording material with a thermal head, a thermal stylus, laser beam or the like, an instant reaction between the electron-donating dye precursor and the electron-accepting compound serving as a color developer occurs and thereby a recorded image is produced. Such a thermal recording material is advantageous, for example, in that records can be made thereon with a relatively simple device ensuring easy maintenance and no noise generation. Therefore, thermal recording materials are widely used for a measuring recorder, a facsimile, a printer, a computer terminal, a label printer, a ticket machine for passenger tickets or other tickets, and the like. Particularly in recent years, thermal recording materials are used as receipts of gas, water, electricity and other bill payments, billing statements issued from ATMs at financial institutions, various receipts, public lotteries, thermal recording labels or tags for point of sales (POS) system, etc.

As the application and demand of thermal recording materials become more diverse, applications for thermal printing of various barcodes are also increasing and thus thermal recording materials suitable for barcode printing are desired. With increase in the amount of information contained in barcodes, the requirements of high definition barcode printing are growing. However, high definition barcodes have a problem that scannability is largely decreased by a slight change in bar width or spacing as a print failure resulting from sticking etc., or by a partial missing resulting from white spot phenomenon. In addition, because of the recent trend towards downsizing and power saving of recording devices, thermal recording materials are increasingly required to be improved in thermal responsiveness and compatibility with devices in terms of thermal recording heads. That is, thermal recording materials that meet the conventional color density requirements even at a lower applied energy in high-speed and power-saving devices and are free from print failure resulting from sticking etc. are desired.

Meanwhile, thermal recording materials used as tickets, chart paper for various devices, cashier receipts, billing statements issued from CDs/ATMs, receipts of gas, water and other bill payments printed by handy terminal devices, etc. may have been subjected to preprinting on the surface on which color images are supposed to be produced by heat. As preprinting, offset printing is usually employed since it can produce clear printed images and is suitable for large-scale printing.

Various thermal recording materials having different components for improvement in offset printability are proposed. For example, Patent Literature 1 discloses a thermal recording material comprising a protective layer with a specific surface tension P of 40 dyne/cm or less, the surface tension being defined by the surface tensions and contact angles of water and flaxseed oil. Patent Literature 2 discloses a thermal recording material comprising a protective layer with a water contact angle of 45 degrees or more. For improvement in anti-sticking property of thermal recording materials, for example, Patent Literature 3 discloses a thermal recording material comprising a protective layer containing an alkylbenzene sulfonate, and Patent Literature 4 discloses a thermal recording material comprising a protective layer containing a fluorosurfactant and a compound selected from an alkyl phosphate, a wax and a higher fatty acid. However, anti-sticking property is hardly compatible with offset printability in thermal recording materials.

On the one hand, using an acetoacetyl-modified polyvinyl alcohol for protective layers in thermal recording materials has been known and is disclosed in, for example, Patent Literature 5, Patent Literature 6, Patent Literature 7, etc. As a crosslinking agent used in combination with an acetoacetyl-modified polyvinyl alcohol, a vinyl sulfone compound is disclosed in Patent Literature 8, a hydrazide compound is disclosed in Patent Literature 9, sebacic acid dihydrazide and dodecanedioic acid dihydrazide are disclosed in Patent Literature 10, an amino-containing silane coupling agent is disclosed in Patent Literature 11, a particular aldehyde compound is disclosed in Patent Literature 12, and a dicarboxylic acid dihydrazide is disclosed in Patent Literature 13. However, these combinations did not achieve sufficient offset printability.

On the other hand, as a thermal recording material that excels in water resistance and color fastness, a thermal recording material comprising a protective layer having crosslinks formed by a glyoxylate and a particular glyoxylic acid ester derivative is disclosed in Patent Literature 14. As an example of thermal recording materials that excel in printability, resistance to allowing deposits to form on thermal heads, water resistance, anti-sticking property, etc., a thermal recording material comprising a protective layer having a carboxy-modified polyvinyl alcohol crosslinked by a polyamideamine epichlorohydrin is disclosed in Patent Literature 15. As an example of thermal recording materials that excel in solvent barrier property and printing ink adhesion, a thermal recording material comprising a protective layer having a silanol-modified polyvinyl alcohol crosslinked by a polyamideamine epichlorohydrin is disclosed in Patent Literature 16 and the like. However, all these inventions are still unsatisfactory.

### CITATION LIST

### Patent Literature

Patent Literature 1: JP-A 04-082777
Patent Literature 2: JP-A 04-014481
Patent Literature 3: JP-A 06-336083
Patent Literature 4: JP-A 2004-136610
Patent Literature 5: JP-A 10-151855
Patent Literature 6: JP-A 10-151856
Patent Literature 7: JP-A 2004-358762
Patent Literature 8: JP-A 2004-034436
Patent Literature 9: JP-A 2004-249528
Patent Literature 10: JP-A 2006-212975
Patent Literature 11: JP-A 2009-039874
Patent Literature 12: JP-A 2009-113438
Patent Literature 13: JP-A 2009-214422
Patent Literature 14: WO 09/028646 pamphlet
Patent Literature 15: JP-A 2005-313597
Patent Literature 16: JP-A 2008-155553

### SUMMARY OF INVENTION

### Technical Problem

An object of the present invention is to provide a solution to the problems described above, namely to provide a thermal recording material that is anti-sticking as well as offset printable, and a method for producing the same.

### Solution To Problem

The above-mentioned object can be basically achieved by a thermal recording material comprising a heat-sensitive recording layer for color formation by heat and a protective layer stacked in this order on a support, the protective layer at least containing an acetoacetyl-modified polyvinyl alcohol crosslinked by a glyoxylate and an epichlorohydrin resin.

The glyoxylate is preferably a metal salt composed of an alkaline earth metal and glyoxylic acid.

The metal salt composed of an alkaline earth metal and glyoxylic acid is preferably calcium glyoxylate or sodium glyoxylate, and more preferably calcium glyoxylate.

The epichlorohydrin resin is preferably a polyamide-epichlorohydrin resin or a polyamine-epichlorohydrin resin, and more preferably a polyamide-epichlorohydrin resin.

The thermal recording material preferably comprises an interlayer containing calcined kaolin and/or a hollow organic pigment between the support and the heat-sensitive recording layer.

The above-mentioned object can be basically achieved by a method for producing a thermal recording material comprising a heat-sensitive recording layer for color formation by heat and a protective layer stacked in this order on a support, the method comprising the steps of:
applying and drying a coating solution for forming the heat-sensitive recording layer on the support; and
applying and drying a coating solution containing an acetoacetyl-modified polyvinyl alcohol, a glyoxylate and an epichlorohydrin resin on the heat-sensitive recording layer to form the protective layer.

As the method for producing a thermal recording material, a method comprising the steps of:
applying and drying a coating solution for forming an interlayer on the support; and
making the heat-sensitive recording layer and the protective layer formed in this order on the interlayer can be also employed.

### Advantageous Effects of Invention

The present invention can provide a thermal recording material that is anti-sticking as well as offset printable, and a method for producing the same.

### DESCRIPTION OF EMBODIMENTS

Hereinafter, the present invention will be described in detail. The protective layer in the thermal recording material of the present invention at least contains an acetoacetyl-modified polyvinyl alcohol crosslinked by a glyoxylate and an epichlorohydrin resin.

The glyoxylate of the present invention is a compound having an aldehyde group in one molecule, the aldehyde group being capable of reacting with an acetoacetyl-modified polyvinyl alcohol to form a crosslink. Examples of the glyoxylate include various kinds of glyoxylates, such as a metal salt composed of an alkali metal and glyoxylic acid, a metal salt composed of an alkaline earth metal and glyoxylic acid, and a salt composed of an amine and glyoxylic acid. Preferred is at least one metal glyoxylate selected from a metal salt composed of an alkali metal and glyoxylic acid and a metal salt composed of an alkaline earth metal and glyoxylic acid. More preferred is a metal salt composed of an alkaline earth metal and glyoxylic acid, and most preferred is calcium glyoxylate. The glyoxylates as used herein include compounds in which the aldehyde group is acetalized or hemiacetalized with an alcohol having up to 3 carbon atoms, such as methanol and ethanol, a diol having up to 3 carbon atoms, such as ethylene glycol and propylene glycol, or the like. Such an acetal group and a hemiacetal group are in equilibrium with an aldehyde group in water or at high temperature since such conditions allow an alcohol moiety to easily dissociate. Therefore, these groups react in the same manner as an aldehyde group does and thus serve as a functional group of a crosslinking agent. According to the present invention, the glyoxylate content is preferably 0.5 to 20 mass %, and particularly preferably 3 to 10 mass % relative to the acetoacetyl-modified polyvinyl alcohol content.

Examples of the epichlorohydrin resin in the present invention include a polyamide-epichlorohydrin resin and a polyamine-epichlorohydrin resin. Specific examples thereof include WS4010, WS4011, WS4020, WS4024, WS4030 and CP8970 [trade name, manufactured by SEIKO PMC CORPORATION (WS4010 and WS4011 are polyamine-epichlorohydrin resins, and the others are polyamide-epichlorohydrin resins)]; and Sumirez Resins 650(30) and 675A [trade name, manufactured by Taoka Chemical Co., Ltd. (both are polyamide-epichlorohydrin resins)]. Inter alia, polyamide-epichlorohydrin resins are preferably used. According to the present invention, the epichlorohydrin resin content is preferably 0.5 to 30 mass %, and particularly preferably 3 to 20 mass % relative to the acetoacetyl-modified polyvinyl alcohol content.

As used herein, the acetoacetyl-modified polyvinyl alcohol refers to a polyvinyl alcohol having an acetoacetyl group introduced in the side chain. The polymerization degree, the saponification degree and the modification degree of the acetoacetyl-modified polyvinyl alcohol are not particularly limited. However, in view of solubility, ease of coating, water resistance of the coat, layer strength and the like, the average polymerization degree is preferably 500 or higher but lower than 4000, the saponification degree is preferably 90% or higher, and the modification degree is preferably about 1 to 10 mol %. According to the present invention, the acetoacetyl-modified polyvinyl alcohol content of the protective layer is preferably 20 to 80 mass %, and particularly preferably 30 to 60 mass % relative to the total solid content of the protective layer.

The protective layer of the present invention can contain a pigment. Examples of the pigment include inorganic pigments such as diatomite, talc, kaolin, calcined kaolin, heavy calcium carbonate, light calcium carbonate, magnesium carbonate, zinc oxide, aluminum oxide, aluminum hydroxide, magnesium hydroxide, titanium dioxide, barium sulfate, zinc sulfate, amorphous silica, amorphous calcium silicate and colloidal silica; and organic pigments such as a melamine resin, a urea-formalin resin, polyethylene, nylon, a styrene plastic pigment, an acrylic plastic pigment and a hydrocarbon plastic pigment. Inter alia, pigments having a tabular structure, such as kaolin and aluminum hydroxide, are preferably used. The pigment content is preferably 10 to 70 mass % relative to the total solid content of the protective layer.

In the protective layer of the present invention, an adhesive other than the above-mentioned acetoacetyl-modified polyvinyl alcohol can be also used unless the desired effects of the present invention are hindered. Specific examples thereof include water soluble resins such as a fully- or partially-saponified polyvinyl alcohol, a diacetone-modified polyvinyl alcohol, a carboxy-modified polyvinyl alcohol, a silicon-modified polyvinyl alcohol, hydroxyethyl cellulose, methyl cellulose, carboxymethylcellulose, gelatin, casein, an alkali salt of a styrene/maleic anhydride copolymer, an alkali salt of an ethylene/acrylic acid copolymer and an alkali salt of a styrene/acrylic acid copolymer; and hydrophobic resins such as styrene-butadiene latex, acrylic latex and urethane latex. The amount of such an additional adhesive is preferably 30 mass % or less, and more preferably 15 mass % or less relative to the acetoacetyl-modified polyvinyl alcohol content.

According to the present invention, in the crosslinking reaction of the acetoacetyl-modified polyvinyl alcohol with a glyoxylate and an epichlorohydrin resin, the pot life of a coating solution and the crosslinking rate are excellently balanced. Therefore, by applying a coating solution containing an acetoacetyl-modified polyvinyl alcohol, a glyoxylate and an epichlorohydrin resin on the heat-sensitive recording layer formed on the support according to a conventionally known technique described later, followed by drying, the acetoacetyl-modified polyvinyl alcohol can be favorably crosslinked by the glyoxylate and the epichlorohydrin resin in the protective layer.

The heat-sensitive recording layer according to the present invention can be obtained by mixing aqueous dispersions each containing a finely-ground component needed for color formation, with a resin and the like; and applying and drying the resulting coating solution on the support.

The electron-donating compound which is contained as a dye precursor in the heat-sensitive recording layer and is usually colorless or light-colored is not particularly limited, and is typified by substances generally used in pressure-sensitive recording materials and thermal recording materials.

Specific examples of the dye precursor include the following:

### (1) Triarylmethane Compounds

3,3-bis(p-dimethylaminophenyl)-6-dimethylamino-phthalide (crystal violet lactone),
3,3-bis(p-dimethylaminophenyl)phthalide,
3-(p-dimethylaminophenyl)-3-(1,2-dimethylindol-3-yl)phthalide,
3-(p-dimethylaminophenyl)-3-(2-methylindol-3-yl)phthalide,
3-(p-dimethylaminophenyl)-3-(2-phenylindol-3-yl)phthalide,
3,3-bis(1,2-dimethylindol-3-yl)-5-dimethylamino-phthalide,
3,3-bis(1,2-dimethylindol-3-yl)-6-dimethylamino-phthalide,
3,3-bis(9-ethylcarbazol-3-yl)-5-dimethylamino-phthalide,
3,3-bis(2-phenylindol-3-yl)-5-dimethylamino-phthalide,
3-p-dimethylaminophenyl-3-(1-methylpyrrol-2-yl)-6-dimethylamino-phthalide, and the like;

### (2) Diphenylmethane Compounds

4,4′-bis(dimethylaminophenyl)benzhydrylbenzyl ether,
N-chlorophenylleucoauramine,
N-2,4,5-trichlorophenylleucoauramine, and the like;

### (3) Xanthene Compounds

rhodamine B anilinolactam, rhodamine B-p-chloroanilinolactam,
3-diethylamino-7-dibenzylaminofluoran,
3-diethylamino-7-octylaminofluoran,
3-diethylamino-7-phenylfluoran,
3-diethylamino-7-chlorofluoran,
3-diethylamino-6-chloro-7-methylfluoran,
3-diethylamino-6-methyl-7-(3-methylphenylamino)fluoran,
3-diethylamino-7-(3,4-dichloroanilino)fluoran,
3-dibutylamino-7-(2-chloroanilino)fluoran,
3-diethylamino-7-(2-chloroanilino)fluoran,
3-diethylamino-6-methyl-7-anilinofluoran,
3-dibutylamino-6-methyl-7-anilinofluoran,
3-dipentylamino-6-methyl-7-anilinofluoran,
3-(N-ethyl-N-tolyl)amino-6-methyl-7-anilinofluoran,
3-piperidino-6-methyl-7-anilinofluoran,
3-(N-ethyl-N-tolyl)amino-6-methyl-7-phenethylfluoran,
3-diethylamino-7-(4-nitroanilino)fluoran,
3-(N-methyl-N-propyl)amino-6-methyl-7-anilinofluoran,
3-(N-ethyl-N-isoamyl)amino-6-methyl-7-anilinofluoran,
3-(N-methyl-N-cyclohexyl)amino-6-methyl-7-anilinofluoran, 3-(N-ethyl-N-tetrahydrofurfuryl)amino-6-methyl-7-anilinofluoran,
3-diethylamino-6-methyl-7-(3-trifluoromethylanilino)fluoran, and the like;

### (4) Thiazine Compounds

benzoyl leucomethylene blue, p-nitrobenzoyl leucomethylene blue, and the like; and

### (5) Spiro Compounds

3-methylspirodinaphthopyran, 3-ethylspirodinaphthopyran,
3,3′-dichlorospirodinaphthopryan,
3-benzylspirodinaphthopyran,
3-methylnaphtho-(3-methoxybenzo)spiropyran,
3-propylspirobenzopyran, and the like.

As needed, these dye precursors can be used alone or as a mixture of two or more kinds thereof.

The electron-accepting compound contained as a color developer in the heat-sensitive recording layer is not particularly limited, and may be, for example, any acidic substance generally used in pressure-sensitive recording materials and thermal recording materials. Examples thereof include phenol derivatives, aromatic carboxylic acid derivatives, N,N′-diarylthiourea derivatives, arylsulfonylurea derivatives, polyvalent metal salts such as zinc salts of an organic compound, benzenesulfonamide derivatives and urea-urethane compounds:

Specific examples of the electron-accepting compound contained in the heat-sensitive recording layer are listed below, but are not necessarily limited to the following compounds.
4-hydroxy-4′-isopropoxy diphenylsulfone,
4-hydroxy-4′-n-propoxy diphenylsulfone, 4,4′-dihydroxy diphenylsulfone, 2,4′-dihydroxy diphenylsulfone, 4-hydroxy diphenylsulfone, 4-hydroxy-4′-methyl diphenylsulfone,
4-hydroxy-4′-methoxy diphenylsulfone, 4-hydroxy-4′-ethoxy diphenylsulfone, 4-hydroxy-4′-n-butoxy diphenylsulfone,
4-hydroxy-4′-benzyloxy diphenylsulfone,
bis(4-hydroxyphenyl)sulfone monoallyl ether,
bis(3-allyl-4-hydroxyphenyl)sulfone,
bis(3,5-dibromo-4-hydroxyphenyl)sulfone,
bis(3,5-dichloro-4-hydroxyphenyl)sulfone, 3,4-dihydroxy diphenylsulfone, 3,4-dihydroxy-4′-methyl diphenylsulfone,
3,4,4′-trihydroxy diphenylsulfone,
4,4′-[oxybis(ethyleneoxy-p-phenylenesulfonyl)]diphenol,
3,4,3′,4′-tetrahydroxy diphenylsulfone, 2,3,4-trihydroxy diphenylsulfone, 3-phenylsulfonyl-4-hydroxy diphenylsulfone,
2,4-bis(phenylsulfonyl)phenol,
4-phenylphenol, 4-hydroxyacetophenone,
1,1-bis(4-hydroxyphenyl)propane,
1,1-bis(4-hydroxyphenyl)pentane,
1,1-bis(4-hydroxyphenyl)hexane,
1,1-bis(4-hydroxyphenyl)cyclohexane,
2,2-bis(4-hydroxyphenyl)propane,
2,2-bis(4-hydroxyphenyl)hexane,
1,1-bis(4-hydroxyphenyl)-2-ethylhexane,
2,2-bis(3-chloro-4-hydroxyphenyl)propane,
1,1-bis(4-hydroxyphenyl)-1-phenylethane,
1,3-bis[1-(4-hydroxyphenyl)-1-methylethyl]benzene,
1,3-bis[1-(3,4-dihydroxyphenyl)-1-methylethyl]benzene,
1,4-bis[1-(4-hydroxyphenyl)-1-methylethyl]benzene,
4,4′-dihydroxy diphenyl ether,
3,3′-dichloro-4,4′-dihydroxydiphenyl sulfide,
bis(2-hydroxynaphthyl)methane,
methyl 2,2-bis(4-hydroxyphenyl)acetate, butyl
2,2-bis(4-hydroxyphenyl)acetate,
4,4-thiobis(2-tert-butyl-5-methylphenol), dimethyl
4-hydroxyphthalate, benzyl 4-hydroxybenzoate, methyl
4-hydroxybenzoate, benzyl gallate, stearyl gallate,
pentaerythritol tetra(4-hydroxybenzoate), pentaerythritol tri(4-hydroxybenzoate),
N-butyl-4-[3-(p-toluenesulfonyl)ureido]benzoate, a dehydration-condensation product from a polycondensate of 2,2-bis(hydroxymethyl)-1,3-propanediol and 4-hydroxybenzoic acid,
N,N′-diphenylthiourea,
4,4′-bis[3-(4-methylphenylsulfonyl)ureido]diphenylmethane,

N-(4-methylphenylsulfonyl)-N′-phenylurea,
N-(benzenesulfonyl)-N′-[3-(4-toluenesulfonyloxy)phenyl]urea,
N-(4-toluenesulfonyl)-N′-[3-(4-toluenesulfonyloxy)phenyl]-urea, urea-urethane compounds,
salicylanilide, 5-chlorosalicylanilide, salicylic acid,
3,5-di-tert-butylsalicylic acid,
3,5-bis(α-methylbenzyl)salicylic acid,
4-[2′-(4-methoxyphenoxy)ethyloxy]salicylic acid,
3-(octyloxycarbonylamino)salicylic acid, or metal salts of these salicylic acid derivatives (for example, zinc salts thereof),
N-(4-hydroxyphenyl)-4-toluenesulfonamide,
N-(2-hydroxyphenyl)-4-toluenesulfonamide,
N-phenyl-4-hydroxybenzenesulfonamide, and the like.

The heat-sensitive recording layer can contain a heat-fusible substance as a sensitizer for improvement in thermal responsiveness. The heat-fusible substance to be used for this purpose has a melting point of preferably 60 to 180° C., and particularly preferably 80 to 140° C.

Specific examples thereof include known heat-fusible substances such as stearamide, N-hydroxymethyl stearamide,

N-stearyl stearamide, ethylenebis(stearamide), methylenebis(stearamide), methylol stearamide, N-stearyl urea, benzyl-2-naphthyl ether, m-terphenyl, 4-benzylbiphenyl, 2,2′-bis(4-methoxyphenoxy)diethyl ether, α,α′-diphenoxy-o-xylene, bis(4-methoxyphenyl)ether, diphenyl adipate, dibenzyl oxalate, bis(4-methylbenzyl)oxalate, bis(4-chlorobenzyl)oxalate, dimethyl terephthalate, dibenzyl terephthalate, phenyl benzenesulfonate, bis(4-allyloxyphenyl)sulfone, 1,2-bis(3-methylphenoxy)ethane, 1,2-diphenoxyethane, 4-acetylacetophenone, acetoacetanilides and fatty acid anilides. More preferred are higher fatty acid amides because they can also serve as a lubricant.

These compounds may be used alone or in a combination of two or more kinds thereof. For sufficient thermal responsiveness, the sensitizer content is preferably 5 to 50 mass % relative to the total solid content of the heat-sensitive recording layer.

In the thermal recording material of the present invention, one or more interlayers can be provided between the support and the heat-sensitive recording layer if needed, for example, for the purpose of increasing color developing sensitivity. In addition, one or more backcoat layers, such as magnetic recording layers, antistatic layers and adhesive layers, can be provided on the back side of the support, i.e. the opposite side of the support from the heat-sensitive recording layer.

The layer(s) other than the above-mentioned protective layer, for example, the support and the optional layers (for example, an interlayer and a backcoat layer) can also contain a pigment together with an adhesive. Examples of the pigment include inorganic pigments such as diatomite, talc, kaolin, calcined kaolin, heavy calcium carbonate, light calcium carbonate, magnesium carbonate, zinc oxide, aluminum oxide, aluminum hydroxide, magnesium hydroxide, titanium dioxide, barium sulfate, zinc sulfate, amorphous silica, amorphous calcium silicate and colloidal silica; and organic pigments such as a melamine resin, a urea-formalin resin, polyethylene, nylon, a styrene plastic pigment, an acrylic plastic pigment and a hydrocarbon plastic pigment. Particularly, as the pigment used for the interlayer, calcined kaolin and/or a hollow sphere organic pigment are preferred. Both of them increase heat insulation of the interlayer, and thus provide the thermal recording material with an excellent thermal responsiveness. For example, using a hollow sphere organic pigment in the interlayer is advantageous as follows. Firstly, hollow sphere organic pigments, which contain air in the hollow, enhance heat insulation. Secondly, hollow sphere organic pigments, which are in an approximately globular form, can be densely arranged without impairing the flexibility of the layer, and thereby provide the interlayer with a high strength and flexibility. Therefore, the thermal recording material in which a hollow sphere organic pigment is used has an excellent thermal responsiveness and surface strength. According to the present invention, the hollow sphere organic pigment refers to a resin pigment having a closed space therein, and more specifically, a homopolymer having, as a main component, a monomer unit such as vinyl chloride, vinylidene chloride, vinyl acetate, styrene, methyl acrylate, ethyl acrylate, butyl acrylate, acrylonitrile, methyl methacrylate, ethyl methacrylate, butyl methacrylate and methacrylonitrile; a copolymer having two or more kinds of the foregoing monomer units; or the like. The hollow sphere organic pigment used for the present invention is not particularly limited as long as the effects of the present invention can be achieved, but preferred is a hollow sphere organic pigment with an average particle diameter of 0.1 to 5.0 μm, and more preferably 0.5 to 2.0 μm. The average particle diameter as used herein is determined by laser diffraction particle size distribution analysis. The hollow sphere organic pigment content is preferably 3 to 80 mass % relative to the total solid content of the interlayer.

The support and the optional layers (for example, an interlayer and a backcoat layer) may contain any kind of resin as an adhesive. Specific examples of the resin include starch, hydroxyethyl cellulose, methyl cellulose, ethyl cellulose, carboxymethylcellulose, gelatin, casein, polyvinyl alcohol, a modified polyvinyl alcohol, polyacrylic acid, polymethacrylic acid, a polyacrylic acid ester, a polymethacrylic acid ester, sodium polyacrylate, polyethylene terephthalate, polybutylene terephthalate, chlorinated polyether, an allyl resin, a furan resin, a ketone resin, oxybenzoylpolyester, polyacetal, polyether ether ketone, polyether sulfone, polyimide, polyamide, polyamideimide, polyaminobismaleimide, polymethylpentene, polyphenylene oxide, polyphenylene sulfide, polyphenylene sulfone, polysulfone, polyarylate, polyallylsulfone, polybutadiene, polycarbonate, polyethylene, polypropylene, polystyrene, polyvinyl chloride, polyvinylidene chloride, polyvinyl acetate, polyurethane, a phenol resin, a urea resin, a melamine resin, a melamine-formalin resin, a benzoguanamine resin, a bismaleimide-triazine resin, an alkyd resin, an amino resin, an epoxy resin, an unsaturated polyester resin, a styrene/butadiene copolymer, an acrylonitrile/butadiene copolymer, a methyl acrylate/butadiene copolymer, an ethylene/vinyl acetate copolymer, an acrylamide/acrylic acid ester copolymer, an acrylamide/acrylic acid ester/methacrylic acid terpolymer, an alkali salt of a styrene/maleic anhydride copolymer, an alkali or ammonium salt of an ethylene/maleic anhydride copolymer, and various polyolefin resins.

Preferably, the protective layer and/or the heat-sensitive recording layer contain a lubricant such as higher fatty acid metal salts, higher fatty acid amides, paraffin, polyolefin, oxidized polyethylene and castor wax for improvement in anti-sticking property etc. The lubricant content is preferably 5 to 50 mass % relative to the total solid content of the protective layer or the heat-sensitive recording layer. Generally, a protective layer containing a lubricant has an improved anti-sticking property, but has a reduced uniformity of the layer surface. This may hinder the uniformity of the printed area when offset printing is performed. However, the present invention can provide a remarkably improved uniformity of the printed area, and thus is effective particularly in the case of such a lubricant-containing layer. If needed, the protective layer and/or the heat-sensitive recording layer may contain ultraviolet absorbers such as benzophenone or benzotriazole compounds for improvement in light resistance etc.; surfactants such as high-molecular-weight anionic or nonionic surfactants as a dispersing and wetting agent; and in addition, fluorescent dyes, defoamants, etc.

As the support of the present invention, any material selected from paper, various woven cloths, a nonwoven cloth, a synthetic resin film, a synthetic resin laminated paper, a synthetic paper, a metallic foil, a vapor deposition sheet and a composite sheet having two or more kinds of the foregoing materials combined by adhesion etc., may be used depending on the purpose. Inter alia, paper, such as acid-free paper and acid paper, is preferably used since the water content is easy to control.

The heat-sensitive recording layer, the protective layer, the interlayer and the backcoat layer can be formed according to a known technique without any particular limitation. Specifically, a coating solution is applied by a technique selected from film press coating, air knife coating, rod blade coating, bar coating, blade coating, gravure coating, curtain coating, extrusion bar coating and the like, and then dried to form the objective layer. Layer formation can be achieved also by use of, for example, various printers such as lithographic printers, letterpress printers, flexographic printers, gravure printers, screen printers and hotmelt printers. Furthermore, any of the following procedures may be employed: coating and subsequent drying are performed for each layer; after successive coating, drying is performed for all the layers (wet-on-wet); and after simultaneous coating, drying is performed for all the layers (simultaneous multilayer coating by slide curtain coating). For sufficient thermal responsiveness, the coating amount for forming the heat-sensitive recording layer is preferably 0.05 to 2.0 g/m², and more preferably 0.1 to 1.0 g/m² in terms of the bone-dry coating amount of the dye precursor. The bone-dry coating amount for forming the protective layer is preferably 0.2 to 10 g/m², and more preferably 1 to 5 g/m². The bone-dry coating amount for forming the interlayer is preferably 1 to 30 g/m², and more preferably 3 to 20 g/m². The bone-dry coating amount for forming the backcoat layer is appropriately selected depending on the function required of the backcoat layer, and the like.

If needed, after coating for forming the interlayer, the heat-sensitive recording layer, the protective layer or the backcoat layer, supercalendering can be performed for improvement in print quality.

### EXAMPLES

Hereinafter, the present invention will be illustrated in more detail by reference to Examples, but is not limited thereto. In the following Examples, “part(s)” and “%” are each on the mass basis, and the coating amount denotes the bone-dry coating amount.

### Example 1

### (1) Preparation of Coating Solution for Forming Interlayer

A mixture of 50 parts of calcined kaolin [manufactured by BASF, trade name: Ansilex], 100 parts of a hollow sphere organic pigment particle dispersion with a solid content of 27.5% [manufactured by Rohm & Haas Company, trade name: HP91], 40 parts of a 50% styrene-butadiene latex, 50 parts of a 10% aqueous oxidized starch solution, and 100 parts of water was stirred, and thus a coating solution for forming the interlayer was prepared.

### (2) Preparation of Coating Solution for Forming Heat-Sensitive Recording Layer—Part 1—

The mixtures (A), (B) and (C) shown below were separately ground by Dyno-Mill (a sand mill manufactured by WAB) so that the volume-average particle diameter was 1 μm or smaller, and thus the respective dispersions were obtained.

### (A) Dye Precursor Dispersion

| | |
|---|---|
| 3-Dibutylamino-6-methyl-7-anilinofluoran | 30 parts |
| 2.5% Aqueous sulfone-modified polyvinyl | 69 parts |
| alcohol solution | |
| 1% Aqueous acetyleneglycol surfactant solution | 1 part |

### (B) Electron-Accepting Compound Dispersion

| | |
|---|---|
| 4-Hydroxy-4′-isopropoxy diphenylsulfone | 30 parts |
| 2.5% Aqueous sulfone-modified polyvinyl | 69 parts |
| alcohol solution | |
| 1% Aqueous acetyleneglycol surfactant solution | 1 part |

### (C) Pigment and Sensitizer Dispersion

| | |
|---|---|
| Aluminum hydroxide [manufactured by Showa Denko K. K., | 50 parts |
| trade name: HIGILITE H42] | |
| 1,2-Bis(3-methylphenoxy)ethane | 30 parts |
| 2.5% Aqueous sulfone-modified polyvinyl | 199 parts |
| alcohol solution | |
| 1% Aqueous acetyleneglycol surfactant solution | 1 part |

### (3) Preparation of Coating Solution for Forming Heat-Sensitive Recording Layer—Part 2—

Next, the dispersions (A), (B) and (C) were mixed with the other components shown below, and the mixture was stirred. Thus, a coating solution for forming the heat-sensitive recording layer was prepared.

| | |
|---|---|
| (A) Dye precursor dispersion | 100 parts |
| (B) Electron-accepting compound dispersion | 100 parts |
| (C) Pigment and sensitizer dispersion | 280 parts |
| 30% Aqueous zinc stearate dispersion | 25 parts |
| [manufactured by Chukyo Yushi Co., Ltd., trade | |
| name: Hidorin Z-7-30] | |
| 40% Aqueous methylol stearamide dispersion | 25 parts |
| 20% Aqueous paraffin wax dispersion | 25 parts |
| 10% Aqueous solution of fully-saponified | 200 parts |
| polyvinyl alcohol [manufactured by KURARAY | |
| CO., LTD., trade name: PVA117] | |
| Water | 100 parts |

### (4) Preparation of Coating Solution for Forming Protective Layer

A coating solution for forming the protective layer was prepared in the following compounding ratio.

| | |
|---|---|
| 10% Aqueous solution of acetoacetyl-modified | 50 parts |
| polyvinyl alcohol [manufactured by The Nippon | |
| Synthetic Chemical Industry Co., Ltd., trade | |
| name: Z-200 (average polymerization degree: | |
| about 1100, saponification degree: 99.0% or | |
| higher)] | |
| 20% Aqueous dispersion of kaolin [manufactured | 20 parts |
| by BASF, trade name: UW90] | |
| 30% Aqueous zinc stearate dispersion | 6 parts |
| [manufactured by Chukyo Yushi Co., Ltd., trade | |
| name: Hidorin Z-7-30] | |
| Calcium glyoxylate | 0.25 part |
| 25% Aqueous polyamide-epichlorohydrin resin | 1 part |
| solution | |
| Water | 30 parts |

### 5) Production of Thermal Recording Material

On an acid-free high-quality roll paper with a basis weight of 66 g/m², the above-prepared coating solutions were applied by an air-knife coater and dried by an air floating drier, so that the solid coating amount was 5 g/m² for the interlayer, 0.5 g/m² for the heat-sensitive recording layer in terms of the dye precursor, and 3 g/m² for the protective layer. Then, calendering was performed, and thus a thermal recording material was prepared.

### Example 2

The same procedures as described in Example 1 were performed to give a thermal recording material, except for using 0.25 part of sodium glyoxylate, instead of 0.25 part of calcium glyoxylate in (4) Preparation of coating solution for forming protective layer.

### Example 3

The same procedures as described in Example 1 were performed to give a thermal recording material, except for using 50 parts of a 10% aqueous solution of acetoacetyl-modified polyvinyl alcohol [manufactured by The Nippon Synthetic Chemical Industry Co., Ltd., trade name: Z-410 (average polymerization degree: about 2300, saponification degree: 97.5 to 98.5%)], instead of 50 parts of the 10% aqueous solution of acetoacetyl-modified polyvinyl alcohol [manufactured by The Nippon Synthetic Chemical Industry Co., Ltd., trade name: Z-200] in (4) Preparation of coating solution for forming protective layer.

### Example 4

The same procedures as described in Example 1 were performed to give a thermal recording material, except for using 1.25 parts of a 20% aqueous polyamine-epichlorohydrin resin solution, instead of 1 part of the 25% aqueous polyamide-epichlorohydrin resin solution in (4) Preparation of coating solution for forming protective layer.

### Example 5

The same procedures as described in Example 1 were performed to give a thermal recording material, except for using 0.05 part of calcium glyoxylate and 1.8 parts of the 25% aqueous polyamide-epichlorohydrin resin solution, instead of 0.25 part of calcium glyoxylate and 1 part of the 25% aqueous polyamide-epichlorohydrin resin solution in (4) Preparation of coating solution for forming protective layer.

### Example 6

The same procedures as described in Example 1 were performed to give a thermal recording material, except for using 0.3 part of calcium glyoxylate and 0.8 part of the 25% aqueous polyamide-epichlorohydrin resin solution, instead of 0.25 part of calcium glyoxylate and 1 part of the 25% aqueous polyamide-epichlorohydrin resin solution in (4) Preparation of coating solution for forming protective layer.

### Comparative Example 1

The same procedures as described in Example 1 were performed to give a thermal recording material, except for using 50 parts of a 10% aqueous solution of fully-saponified polyvinyl alcohol [manufactured by The Nippon Synthetic Chemical Industry Co., Ltd., trade name: NM-11], instead of 50 parts of the 10% aqueous solution of acetoacetyl-modified polyvinyl alcohol [manufactured by The Nippon Synthetic Chemical Industry Co., Ltd., trade name: Z-200].

### Comparative Example 2

The same procedures as described in Example 1 were performed to give a thermal recording material, except for using 50 parts of a 10% aqueous solution of carboxy-modified polyvinyl alcohol [manufactured by KURARAY CO., LTD., trade name: KL-318], instead of 50 parts of the 10% aqueous solution of acetoacetyl-modified polyvinyl alcohol [manufactured by The Nippon Synthetic Chemical Industry Co., Ltd., trade name: Z-200].

### Comparative Example 3

The same procedures as described in Example 1 were performed to give a thermal recording material, except for using 50 parts of a 10% aqueous solution of silanol-modified polyvinyl alcohol [manufactured by KURARAY CO., LTD., trade name: R-1130], instead of 50 parts of the 10% aqueous solution of acetoacetyl-modified polyvinyl alcohol [manufactured by The Nippon Synthetic Chemical Industry Co., Ltd., trade name: Z-200].

### Comparative Example 4

The same procedures as described in Example 1 were performed to give a thermal recording material, except for using 2 parts of the 25% aqueous polyamide-epichlorohydrin resin solution, instead of 0.25 part of calcium glyoxylate and 1 part of the 25% aqueous polyamide-epichlorohydrin resin solution in (4) Preparation of coating solution for forming protective layer.

### Comparative Example 5

The same procedures as described in Example 1 were performed to give a thermal recording material, except for using 0.25 part of adipic acid dihydrazide, instead of 0.25 part of calcium glyoxylate in (4) Preparation of coating solution for forming protective layer.

### Comparative Example 6

The same procedures as described in Example 1 were performed to give a thermal recording material, except for using 0.5 part of calcium glyoxylate, instead of 0.25 part of calcium glyoxylate and 1 part of the 25% aqueous polyamide-epichlorohydrin resin solution in (4) Preparation of coating solution for forming protective layer.

### Comparative Example 7

The same procedures as described in Example 1 were performed to give a thermal recording material, except for using 0.25 part of adipic acid dihydrazide, instead of 1 part of the 25% aqueous polyamide-epichlorohydrin resin solution in (4) Preparation of coating solution for forming protective layer.

### Comparative Example 8

The same procedures as described in Example 1 were performed to give a thermal recording material, except for using 0.63 part of a 40% aqueous glyoxal solution, instead of 1 part of the 25% aqueous polyamide-epichlorohydrin resin solution in (4) Preparation of coating solution for forming protective layer.

### Comparative Example 9

The same procedures as described in Example 1 were performed to give a thermal recording material, except for using 0.56 part of a 45% aqueous zirconium ammonium carbonate solution, instead of 1 part of the 25% aqueous polyamide-epichlorohydrin resin solution in (4) Preparation of coating solution for forming protective layer.

### Comparative Example 10

The same procedures as described in Example 1 were performed to give a thermal recording material, except for using 1 part of a 25% aqueous methylol melamine resin solution, instead of 1 part of the 25% aqueous polyamide-epichlorohydrin resin solution in (4) Preparation of coating solution for forming protective layer.

The thermal recording materials produced in Examples 1 to 6 and Comparative Examples 1 to 10 were evaluated as below. The results are shown in Table 1.

### <Print Density>

On each of the produced thermal recording materials, printing was performed using a facsimile tester (manufactured by Okura Engineering Co., LTD., model: TH-PMD). The tester was equipped with a thermal head featuring a dot density of 8 dots/mm and a head resistance of 1,685Ω. Black solid printing and letter printing were performed at an applied voltage of 20 V and at an applied pulse-width of 1.0 msec. The print density was measured with Macbeth reflection densitometer model RD-918 (visual filter) (manufactured by Macbeth). The practical lower limit of the print density is 1.0, and the preferable print density is 1.2 or more.

### <Anti-Sticking Property>

Printing was performed under an environmental condition of 5° C. using a printer manufactured by Canon, Inc. (trade name: PRea CT-1). The degree of sticking on the printed surface was evaluated on a four-grade scale. The evaluation criteria used are as follows.
A: no sticking is observed at all.
B: very slight sticking is observed.
C: sticking is observed.
D: sticking is observed on the whole surface.

### <Offset Printability>

Offset printing was performed using an RI printer. The ink for offset printing was prepared by adding 0.5 ml of water to 0.25 g of a UV ink [trade name: BEST CURE UV NVR magenta, manufactured by T&K TOKA CO., LTD] and kneading the mixture with an ink kneading roller for 1 minute for emulsification. Under UV irradiation, the uniformity of the printed area was visually evaluated on a four-grade scale. The evaluation criteria used are as follows.
A: very good
B: good
C: poor
D: very poor

TABLE 1

| | | Anti-sticking | Offset |
|---|---|---|---|
| | Print density | property | printability |
| Ex 1 | 1.34 | A | A |
| Ex 2 | 1.34 | B | A |
| Ex 3 | 1.35 | A | A |
| Ex 4 | 1.34 | B | B |
| Ex 5 | 1.33 | A | A |
| Ex 6 | 1.35 | A | A |
| CEx 1 | 1.32 | D | D |
| CEx 2 | 1.33 | D | D |
| CEx 3 | 1.36 | D | D |
| CEx 4 | 1.31 | D | C |
| CEx 5 | 1.33 | C | C |
| CEx 6 | 1.35 | B | D |
| CEx 7 | 1.35 | B | D |
| CEx 8 | 1.34 | B | D |
| CEx 9 | 1.33 | B | D |
| CEx 10 | 1.33 | B | D |

Ex: Example
CEx: Comparative Example

As clearly shown in Table 1, in any of the thermal recording materials of Examples 1 to 6, the print density was high and the anti-sticking property and the offset printability were favorable. Therefore, the present invention can provide a thermal recording material that is anti-sticking as well as offset printable. Meanwhile, the thermal recording materials of Comparative Examples 1 to 6, which lacked one of a glyoxylate, an epichlorohydrin resin and an acetoacetyl-modified polyvinyl alcohol as a component of the protective layer, were inferior in at least one of anti-sticking property and offset printability.

1. A thermal recording material comprising a heat-sensitive recording layer for color formation by heat and a protective layer stacked in this order on a support, the protective layer at least containing an acetoacetyl-modified polyvinyl alcohol crosslinked by a glyoxylate and an epichlorohydrin resin.

2. The thermal recording material according to claim 1, wherein the glyoxylate is a metal salt composed of an alkaline earth metal and glyoxylic acid.

3. The thermal recording material according to claim 2, wherein the metal salt composed of an alkaline earth metal and glyoxylic acid is calcium glyoxylate or sodium glyoxylate.

4. The thermal recording material according to claim 3, wherein the metal salt composed of an alkaline earth metal and glyoxylic acid is calcium glyoxylate.

5. The thermal recording material according to any one of claims 1 to 4, wherein the epichlorohydrin resin is a polyamide-epichlorohydrin resin or a polyamine-epichlorohydrin resin.

6. The thermal recording material according to claim 5, wherein the epichlorohydrin resin is a polyamide-epichlorohydrin resin.

7. The thermal recording material according to any one of claims 1 to 4, comprising an interlayer containing calcined kaolin and/or a hollow organic pigment between the support and the heat-sensitive recording layer.

8. A method for producing a thermal recording material comprising a heat-sensitive recording layer for color formation by heat and a protective layer stacked in this order on a support, the method comprising the steps of:
applying and drying a coating solution for forming the heat-sensitive recording layer on the support; and
applying and drying a coating solution containing an acetoacetyl-modified polyvinyl alcohol, a glyoxylate and an epichlorohydrin resin on the heat-sensitive recording layer to form the protective layer.

9. A method for producing a thermal recording material comprising a heat-sensitive recording layer for color formation by heat and a protective layer stacked in this order on a support, the method comprising the steps of:
applying and drying a coating solution for forming an interlayer on the support;
applying and drying a coating solution for forming the heat-sensitive recording layer on the interlayer; and
applying and drying a coating solution containing an acetoacetyl-modified polyvinyl alcohol, a glyoxylate and an epichlorohydrin resin on the heat-sensitive recording layer to form the protective layer.

10. The thermal recording material according to claim 5, comprising an interlayer containing calcined kaolin and/or a hollow organic pigment between the support and the heat-sensitive recording layer.

11. The thermal recording material according to claim 6, comprising an interlayer containing calcined kaolin and/or a hollow organic pigment between the support and the heat-sensitive recording layer.
